(19) United States
(12) Patent Application Publication
(10) Pub. No.: US 2011/0279447 A1
(43) Pub. Date: Nov. 17, 2011

(54) Rendering Transparent Geometry

(75) Inventor: Alexander Nankervis, Austin, TX (US)

(73) Assignee: Zebra Imaging, Inc., Austin, TX (US)

(21) Appl. No.: 12/780,927

(22) Filed: May 16, 2010

(51) Int. Cl. G06T 15/00

(52) U.S. Cl. 345/419

(57) ABSTRACT

Methods and systems for rendering 3D scenes, including rendering a portion of the 3D scene to a corresponding pixel to determine a pixel value, determining a designated-next multisample of the corresponding pixel, and storing the pixel value at the designated-next multisample in response to determining that a depth value of the portion of the 3D scene is less than a depth value stored at the designated-next multisample.

### BACKGROUND

The invention relates generally to the field of graphics rendering and more particularly to rendering 3D scenes with transparency.

### SUMMARY

In one respect, disclosed is a method A method for rendering 3D data, the method comprising providing a 2D video buffer, the 2D video buffer comprising an array of pixels, each pixel comprising two or more multisamples, providing a portion of a 3D scene, the portion of the 3D scene comprising transparent geometry, rendering the portion of the 3D scene to a corresponding pixel to determine a pixel value, determining a designated-next multisample of the corresponding pixel, storing the pixel value at the designated-next multisample in response to determining that a depth value of the portion of the 3D scene is less than a depth value stored at the designated-next multisample.

In another respect, disclosed is a system for rendering 3D data, the system comprising one or more processors, one or more memory units coupled to the one or more processors, the system being configured to provide a 2D video buffer, the 2D video buffer comprising an array of pixels, each pixel comprising two or more multisamples, provide a portion of a 3D scene, the portion of the 3D scene comprising transparent geometry, render the portion of the 3D scene to a corresponding pixel to determine a pixel value, determine a designated-next multisample of the corresponding pixel, store the pixel value at the designated-next multisample in response to determining that a depth value of the portion of the 3D scene is less than a depth value stored at the designated-next multisample.

In yet another respect, disclosed is a computer program product embodied in a computer-operable medium, the computer program product comprising logic instructions, the logic instructions being effective to be provided a 2D video buffer, the 2D video buffer comprising an array of pixels, each pixel comprising two or more multisamples, be provided a portion of a 3D scene, the portion of the 3D scene comprising transparent geometry, render the portion of the 3D scene to a corresponding pixel to determine a pixel value, determine a designated-next multisample of the corresponding pixel, store the pixel value at the designated-next multisample in response to determining that a depth value of the portion of the 3D scene is less than a depth value stored at the designated-next multisample.

Numerous additional embodiments are also possible.

### BRIEF DESCRIPTION OF THE DRAWINGS

Other objects and advantages of the invention may become apparent upon reading the detailed description and upon reference to the accompanying drawings.

FIG. 1 is a block diagram illustrating a system for rendering a 3D scene with transparency, in accordance with some embodiments.

FIG. 2 is a diagram illustrating a pixel, the pixel's four multisamples, and the values stored for each multisample, in accordance with some embodiments.

FIG. 3 is a flow diagram illustrating a method for rendering 3D scene with transparent geometry, in accordance with some embodiments.

FIG. 4 is a flow diagram illustrating a method for rendering 3D scene with opaque geometry, in accordance with some embodiments.

FIG. 5 is a flow diagram illustrating a method for combining transparent and opaque color values stored at a pixel's multisamples to determine the pixel's color value, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

In some embodiments, systems and methods for rendering 3D scenes are considered. In some embodiments, pixels to be rendered at one or more frames may be stored in a 2D buffer. In addition, each pixel may comprise a number of multisamples (NMS, for example, 4, 8, 16, etc.), in some embodiments, for increasing the quality of the rendered images. In some embodiments, each pixel and, in addition, each multisample may be associated with a color buffer for storing RBG color values, a depth buffer for storing depth (z value) information, a transparency buffer for storing transparency (alpha value) information, a stencil buffer for storing additional information, etc. In some embodiments, the 3D scene may comprise opaque geometry as well as transparent geometry. The alpha value may be used to indicate the level of transparency with alpha=1 indicating opaque geometry and alpha=0 indicating completely transparent geometry.

In some embodiments, various techniques may be implemented for rendering transparent and opaque geometry. For transparent geometry, a corresponding pixel (or pixels as it may be appropriate) may be determined for a given portion of the 3D geometry after selecting and applying an appropriate geometric projection and/or other techniques according to the type of rendering required. In some embodiments, for transparent geometry, the rendering may be performed with respect to the position of the pixel and not with respect to the position of the multisamples even in embodiments where multisampling may be used for other types of geometry (such as opaque geometry, for example).

The projection and/or other rendering techniques yield a pixel value corresponding to the transparent geometry. The rendered pixel value may be then assigned to a designated-next multisample. In some embodiments, the designated-next multisample may be determined by utilizing the stencil buffer associated with each multisample. In some embodiments, the stencil buffers for the multisamples in a pixel may be initialized sequentially from 0 to the number of multisamples per pixel minus 1 (NMS−1). The designated-next multisample may be then determined by evaluating which multisample yields a 0 when then number stored in the multisample's stencil is bitwise ANDed with NMS−1. For example, if four multisamples are used (NMS=4), the designated-next multisample will be, at least initially, the multisample having a 0 in its stencil since: 00 AND 11 (3 in binary)=00.

In some embodiments, an additional depth value test may be performed before the pixel value is assigned to the designated-next multisample in order to determine whether the new value has an associated depth value that is less than the depth value stored at the multisample (in other words the new value is “in front” of the stored value). The multisample value, in some embodiments, is replaced only response to the depth value being less than the stored value. In addition, after replacing the pixel value, all the stencil numbers of the pixel are incremented by one, thereby cycling though all the multisamples in a pixel as the designated-next multisample.

In some embodiments, geometry comprising opaque geometry may be rendered utilizing traditional multisampling rendering. Each corresponding portion of the opaque geometry may be projected to a corresponding multisample according to the location of the multisample. Newer rendered values replace existing values in the multisamples in response to determining that the newer values have smaller depth values. Opaque geometry rendering, therefore, takes advantage of the multisamples per pixel to yield higher quality rendering.

In some embodiments and after completion of the rendering of all of the 3D scene geometry, the color values stored in the multisamples may be combined in order to determine a combined color value for the corresponding pixel. The multisamples may be first sorted into a per pixel list by decreasing depth value. Consecutive opaque multisample color values starting with the highest depth value (if any) may be first averaged (other techniques may also be used) to generate an average opaque color value.

After the combining of the first sequential opaque values, the combining process may then continue by sequentially including remaining transparent multisample color values (again if any). The next transparent multisample value, for example, may be combined with the average opaque value obtained above using a weighted average with the weight for the transparent value being the multisample's stored alpha value. Each remaining transparent multisample value may be then sequentially weighted averaged (using again the alpha values) with the last obtained average value until all the multisample values have been combined to determine the final pixel color value.

[alex, are there any other details to include here?]

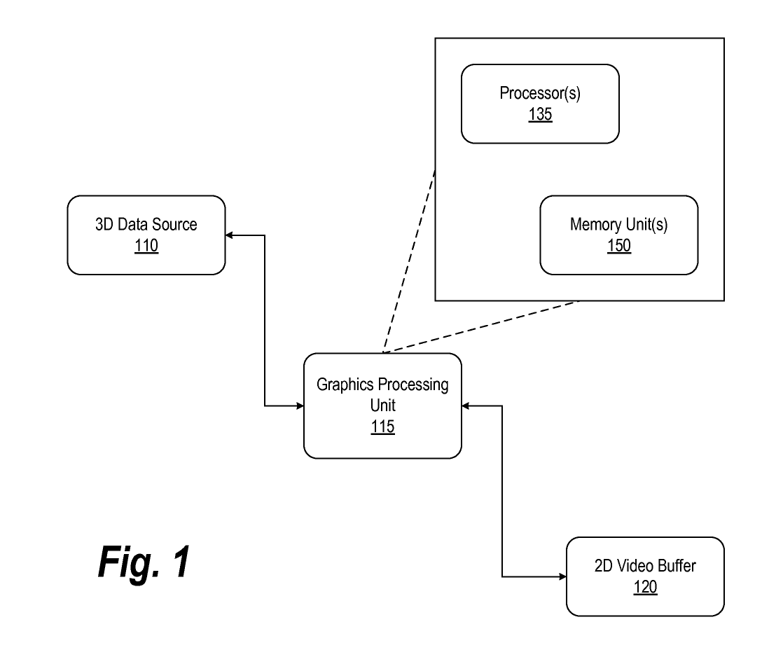

FIG. 1 is a block diagram illustrating a system for rendering a 3D scene with transparency, in accordance with some embodiments.

In some embodiments, 3D data source 110 is configured to generate and provide 3D data and/or commands. The 3D data source 110 may be, for example, a 3D application executing on a workstation, generating commands and data in a graphics language such as OpenGL, DirectX, etc.

Graphics processing unit 115 is configured to receive the 3D data and commands from 3D data source 110 and to render the 3D data and commands into one or more 2D views. In some embodiments, a custom graphics processing unit may be used. In alternative embodiments, existing graphics processing units may be used. The existing processing units may be modified/programmed in order to enable additional functionality for the units as needed. In some embodiments, the functionality of graphics processing unit 115 may be generally implemented using one or more processors 135 and one or more memory units 150.

2D video buffer 120 may be configured to store the 2D rendering results (for each frame, for example) of 2D data generated by the graphics processing unit 115. In some embodiments, the 2D video buffer may comprise pixels (that may correspond to a 2D display, for example), each pixel being associated with one or more values such as color values, transparency (alpha) values, depth (z) values, stencil values for various uses, etc. In addition, 2D video buffer may comprise two or more (typically 4, 8, 16, etc.) multisamples per pixel, each multisample each multisample being also associated with values such as color values, transparency (alpha) values, depth (z) values, stencil values for various uses, etc. In some embodiments, 2D video buffer 120 may be incorporated into graphics processing unit 115.

In some embodiments, as described above, graphics processing unit 115 may be configured to render opaque as well as transparent geometry as described above into the two or more multisamples per pixel and to then combine those multisamples to yield a combined pixel value.

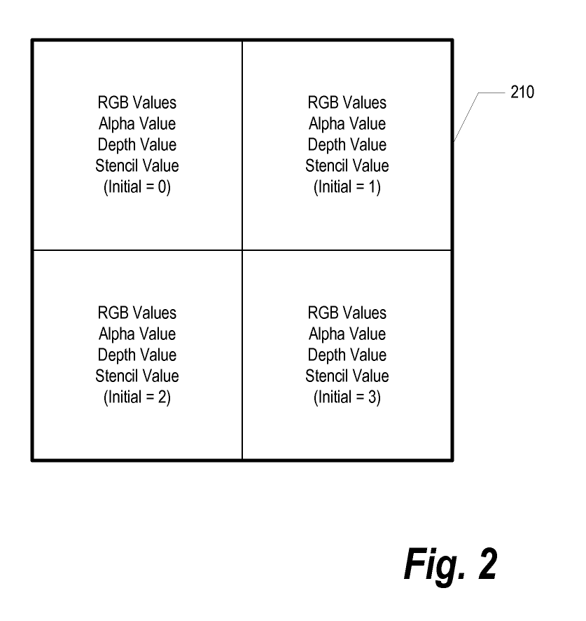

FIG. 2 is a diagram illustrating a pixel, the pixel's four multisamples, and the values stored for each multisample, in accordance with some embodiments.

In this example, pixel 210 comprises four multisamples. In other embodiments, other numbers of multisamples may be used, such as 8, 16, etc. In some embodiments, each multisample of pixel 210 and pixel 210 may be associated with one or more values. The values may include, for example: color red, green, and blue values; transparency alpha values; depth z values; stencil values, etc. In some embodiments, the initial stencil values for the multisamples may be initialized to the values 0, 1, 2, 3 in order to implement the rendering of transparent geometry as described above. In some embodiments, pixel 210 may also be associated with values that may include for example: color red, green, and blue values; transparency alpha values; depth z values; stencil values, etc.

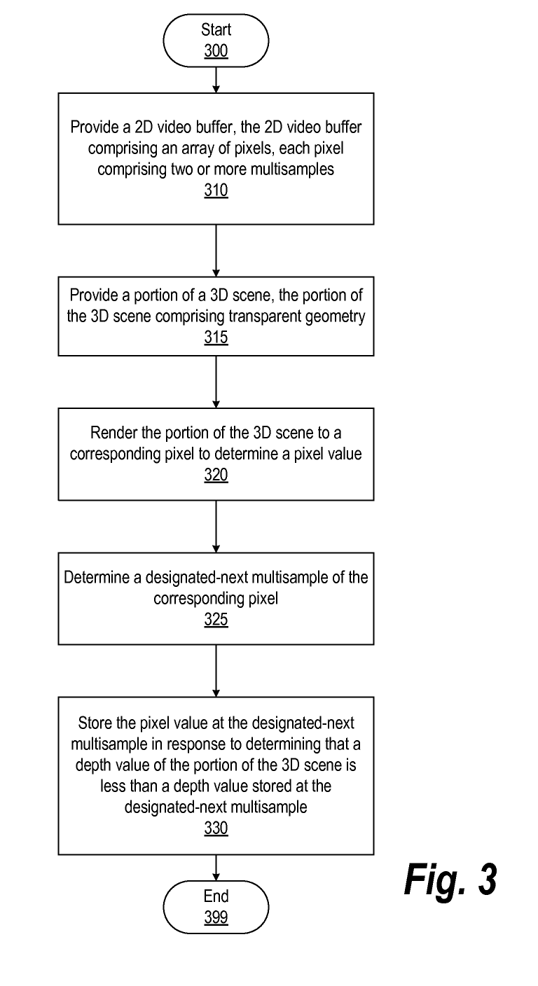

FIG. 3 is a flow diagram illustrating a method for rendering 3D scene with transparent geometry, in accordance with some embodiments.

In some embodiments, the method illustrated in FIG. 3 may be performed by the system illustrated in FIG. 1. Processing begins at 300 whereupon, at block 310, a 2D video buffer is provided. In some embodiments, the 2D video buffer comprises an array of pixels, each pixel comprising two or more multisamples.

At block 315, a portion of a 3D scene is provided. The portion of the 3D scene may comprise transparent geometry in addition to other types of geometry such as opaque geometry.

At block 320, the portion of the 3D scene may be rendered to a corresponding pixel to determine a pixel color value. Various types of projections and other methods may be used to determine the value of the corresponding pixel from the portion of the 3D scene.

At block 325, a designated-next multisample of the corresponding pixel is determined. In some embodiments, the multisamples of the pixel are sequentially assigned to be designated-next multisample.

At block 330, the pixel value is stored at the designated-next multisample in response to determining that a depth value of the portion of the 3D scene is less than a depth value stored at the designated-next multisample.

Processing subsequently ends at 399.

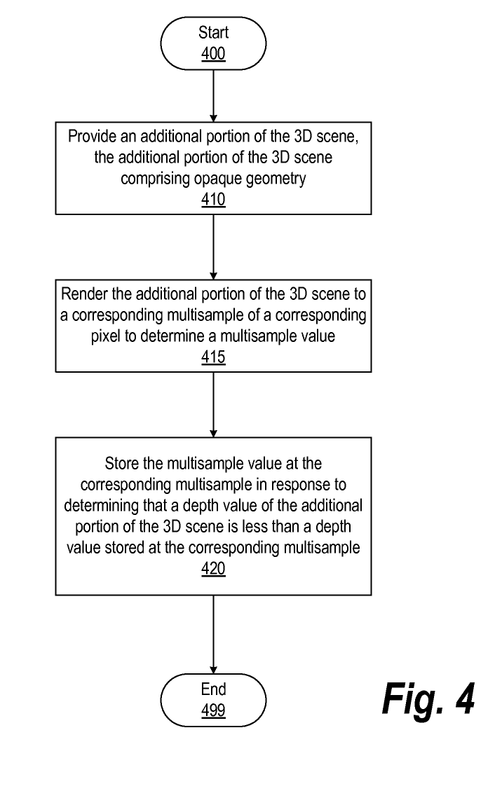

FIG. 4 is a flow diagram illustrating a method for rendering 3D scene with opaque geometry, in accordance with some embodiments.

In some embodiments, the method illustrated in FIG. 4 may be performed by the system illustrated in FIG. 1. Processing begins at block 400 whereupon, at block 410, an additional portion of the 3D scene is provided. In some embodiments, the additional portion of the 3D scene may comprise opaque geometry in addition to other types of geometry, such as transparent geometry.

At block 415, the additional portion of the 3D scene may be rendered to a corresponding multisample of a corresponding pixel to determine a multisample value. In some embodiments, various types of projections and other methods may be used to render the additional portion of the 3D scene.

At block 420, the multisample value is stored at the corresponding multisample in response to determining that a depth value of the additional portion of the 3D scene is less than a depth value stored at the corresponding multisample.

Processing subsequently ends at 499

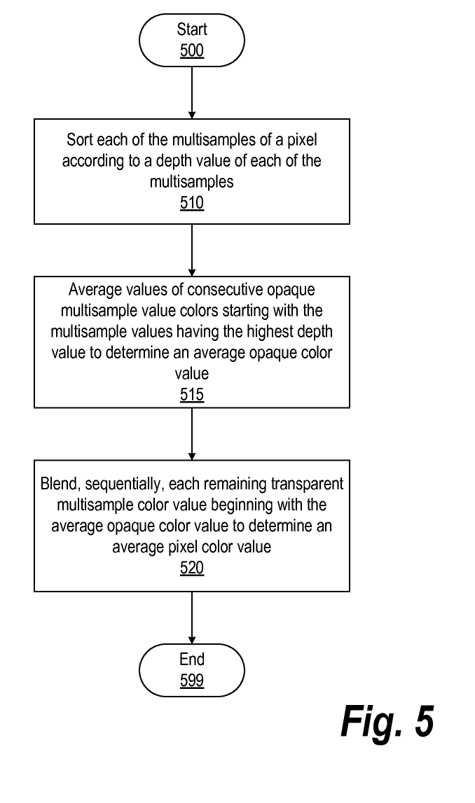

FIG. 5 is a flow diagram illustrating a method for combining transparent and opaque color values stored at a pixel's multisamples to determine the pixel's color value, in accordance with some embodiments.

In some embodiments, the method illustrated in FIG. 5 may be performed by the system illustrated in FIG. 1. Processing begins at block 500 whereupon, at block 510, the multisamples of a pixel are sorted according to a depth value of each of the multisamples. In some embodiments, the multisamples with the highest depth values are at the top of the sorted list.

At block 515, values of consecutive opaque multisample value colors are averaged starting with the multisample values having the highest depth value to determine an average opaque color value. In some embodiments, the average includes all of the opaque multisamples from the top of the sorted list until just before the first transparent multisample.

At block 520, each remaining transparent multisample color value is blended, sequentially, beginning with the average opaque color value to determine an average pixel color value. In some embodiments, a sequential weighted average is determined by sequentially considering each of the transparent multisample values. The weight used in each case may the transparency (alpha) value associated with each of the multisamples.

Processing subsequently ends at 599.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method for rendering 3D data, the method comprising:
providing a 2D video buffer, the 2D video buffer comprising an array of pixels, each pixel comprising two or more multisamples;
providing a portion of a 3D scene, the portion of the 3D scene comprising transparent geometry;
rendering the portion of the 3D scene to a corresponding pixel to determine a pixel value;
determining a designated-next multisample of the corresponding pixel;
storing the pixel value at the designated-next multisample in response to determining that a depth value of the portion of the 3D scene is less than a depth value stored at the designated-next multisample.

2. The method of claim 1, further comprising:
providing an additional portion of the 3D scene, the additional portion of the 3D scene comprising opaque geometry;
rendering the additional portion of the 3D scene to a corresponding multisample of a corresponding pixel to determine a multisample value; and
storing the multisample value at the corresponding multisample in response to determining that a depth value of the additional portion of the 3D scene is less than a depth value stored at the corresponding multisample.

3. The method of claim 2, further comprising:
sorting the multisamples of a pixel according to a depth value of each of the multisamples;
averaging values of consecutive opaque multisample value colors starting with the multisample values having the highest depth value to determine an average opaque color value; and
blending, sequentially, each remaining transparent multisample color value beginning with the average opaque color value to determine an average pixel color value.

4. The method of claim 3, further comprising numbering each multisample in a pixel starting from 0, storing the number in a stencil buffer associated with the multisample.

5. The method of claim 4, where determining a designated-next multisample comprises determining whether a multisample's stencil value bitwise ANDed with the (number of multisamples minus 1) is equal to zero.

6. The method of claim 5, further comprising incrementing the numbers in the stencil buffer of the multisamples in response to storing the pixel value in the designated-next multisample.

7. A system for rendering 3D data, the system comprising:
one or more processors;
one or more memory units coupled to the one or more processors, the system being configured to:
provide a 2D video buffer, the 2D video buffer comprising an array of pixels, each pixel comprising two or more multisamples;
provide a portion of a 3D scene, the portion of the 3D scene comprising transparent geometry;
render the portion of the 3D scene to a corresponding pixel to determine a pixel value;
determine a designated-next multisample of the corresponding pixel;
store the pixel value at the designated-next multisample in response to determining that a depth value of the portion of the 3D scene is less than a depth value stored at the designated-next multisample.

8. The system of claim 7, the system being further configured to:
provide an additional portion of the 3D scene, the additional portion of the 3D scene comprising opaque geometry;
render the additional portion of the 3D scene to a corresponding multisample of a corresponding pixel to determine a multisample value; and
store the multisample value at the corresponding multisample in response to determining that a depth value of the additional portion of the 3D scene is less than a depth value stored at the corresponding multisample.

9. The system of claim 8, the system being further configured to:
sort the multisamples of a pixel according to a depth value of each of the multisamples;
average values of consecutive opaque multisample value colors starting with the multisample values having the highest depth value to determine an average opaque color value; and
blend, sequentially, each remaining transparent multisample color value beginning with the average opaque color value to determine an average pixel color value.

10. The system of claim 9, the system being further configured to number each multisample in a pixel starting from 0, storing the number in a stencil buffer associated with the multisample.

11. The system of claim 10, where the system being configured to determine a designated-next multisample comprises the system being configured to determine whether a multisample's stencil value bitwise ANDed with the (number of multisamples minus 1) is equal to zero.

12. The system of claim 11, the system being further configured to increment the numbers in the stencil buffer of the multisamples in response to storing the pixel value in the designated-next multisample.

13. A computer program product embodied in a computer-operable medium, the computer program product comprising logic instructions, the logic instructions being effective to:
be provided a 2D video buffer, the 2D video buffer comprising an array of pixels, each pixel comprising two or more multisamples;
be provided a portion of a 3D scene, the portion of the 3D scene comprising transparent geometry;
render the portion of the 3D scene to a corresponding pixel to determine a pixel value;
determine a designated-next multisample of the corresponding pixel;
store the pixel value at the designated-next multisample in response to determining that a depth value of the portion of the 3D scene is less than a depth value stored at the designated-next multisample.

14. The product of claim 13, the instructions being further effective to:
be provided an additional portion of the 3D scene, the additional portion of the 3D scene comprising opaque geometry;
render the additional portion of the 3D scene to a corresponding multisample of a corresponding pixel to determine a multisample value; and
store the multisample value at the corresponding multisample in response to determining that a depth value of the additional portion of the 3D scene is less than a depth value stored at the corresponding multisample.

15. The product of claim 14, the instructions being further effective to:
sort the multisamples of a pixel according to a depth value of each of the multisamples;
average values of consecutive opaque multisample value colors starting with the multisample values having the highest depth value to determine an average opaque color value; and
blend, sequentially, each remaining transparent multisample color value beginning with the average opaque color value to determine an average pixel color value.

16. The product of claim 15, the instructions being further effective to number each multisample in a pixel starting from 0, storing the number in a stencil buffer associated with the multisample.

17. The product of claim 16, where the instructions being effective to determine a designated-next multisample comprises the instructions being effective to determine whether a multisample's stencil value bitwise ANDed with the (number of multisamples minus 1) is equal to zero.

18. The product of claim 17, the instructions being further effective to increment the numbers in the stencil buffer of the multisamples in response to storing the pixel value in the designated-next multisample.
